(19) United States
(12) Patent Application Publication
(10) Pub. No.: US 2003/0115157 A1
(43) Pub. Date: Jun. 19, 2003

(54) Multi-system capacity on demand computer pricing

(76) Inventor: Edgar Circenis, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/014,908

(22) Filed: Dec. 14, 2001

(51) Int. Cl. G06F 17/00

(52) U.S. Cl. 705/400

(57) ABSTRACT

A multi-computer instant capacity on demand (iCOD) system enables a customer to purchase computers with some assets inactive at a reduced price and to pool the total assets across all of the computers on the customers computer network. Each computer in the network transmits usage reports to a vendor database where the total number of inactive assets are added up by class of assets to determine if the customer has paid for all activated assets for all the computers on the network, rather than by individual computer. The customers may further organize computers into clusters, where the assets are audited by cluster rather than by individual computer or by the entire network. The network can have more than one cluster.

### TECHNICAL FIELD

The technical field is logging and measuring of usage metrics for multiple computer systems on a computing network.

### BACKGROUND

Instant capacity on demand (“iCOD”) purchasing of high-end computers gives customers the flexibility to acquire high capacity computer systems without the normal single large capital outlay. The iCOD customer pays only for active central processing units (CPUs) in a given computer system, plus some maintenance fees, while the computer system may include a number of inactive CPUs. The iCOD customer takes title to all of the CPUs but is only licensed to use the active CPUs. The iCOD customer then is able to activate the inactive CPUs at a later time using system administration commands and to pay for licenses for the newly activated CPUs, which are priced at market rates for the CPUs. In this manner the iCOD customer is able to flexibly scale up computing power as the iCOD customer's needs change.

Current iCOD systems send an iCOD audit report to an auditing system belonging to the iCOD system vendor. The iCOD audit report will typically show the CPUs that are inactive and the total number of CPUs. Inactive capacity is measured because the iCOD customer is free to add non-iCOD CPUs, but is not permitted to activate inactive iCOD CPUs without paying additional licensing fees. An expected number of inactive CPUs corresponds to the iCOD CPUs that the customer owns but has not paid to activate, and a comparison is made between the reported totals of inactive CPUs and the expected totals of inactive CPUs. A reminder or bill may be issued if the iCOD reports show less inactive CPU capacity than that which was originally expected, as any reduction in inactive CPU capacity implies additional CPUs have been activated without being paid for. The iCOD pricing system thus permits the iCOD customer to pay for the processing power that the customer is actually using on a given system but also gives the iCOD customer the ability to easily expand the customer's system should needs change.

The iCOD customer cannot easily deactivate CPUs on the system, however, and get a refund for deactivated CPUs. The iCOD vendor does not generally give a customer a refund for CPUs that have been activated and purchased and later deactivated. Otherwise a customer might deactivate the CPU after a temporary period and get a nearly full refund, even though the customer has already used the additional CPU for the temporary period. Such activation and deactivation may be allowed in a pay-per-use or leasing pricing plan, but such pay-per-use plans would be priced quite differently. An iCOD CPU activation would be at the market rate for that CPU whereas a pay-per-use plan would be priced month to month.

The current iCOD pricing system also treats each iCOD system individually for purposes of auditing the CPU totals. An iCOD customer with four iCOD computers thus has four individual and separate iCOD contracts or accounts. Using the current iCOD system, the iCOD customer who has more active CPUs than necessary on one iCOD computer but insufficient CPUs on a second iCOD computer cannot shift the “excess” CPUs from the first iCOD computer to the second iCOD computer. Rather, this iCOD customer must pay to activate additional CPUs on the second iCOD computer.

### SUMMARY

An iCOD auditing system that audits assets across a multiplicity of computers gives an iCOD customer greater flexibility in purchasing iCOD computers. iCOD computers send iCOD audit reports detailing the number of active assets by class of assets to a vendor's auditing system. An auditing program in the auditing system interprets the iCOD audit report and totals the number of assets by class of assets for all or a specified subset of the computers. The auditing system then effectively checks the number of inactive assets to see if additional inactive assets have been activated without being paid for. The auditing system provides a notification that the iCOD customer has newly activated assets and must pay the vendor for these activations. This multi-system technology can be applied to any assets covered by an iCOD agreement, such as central processing units (CPUs), hard disk capacity or memory, for example.

In an embodiment, iCOD computers are grouped into clusters to allow more flexibility in managing and grouping of iCOD computers. The customer may determine cluster membership for each of the iCOD computers (including possibly a cluster comprised of a single iCOD computer). The auditing system interprets the audit reports from all iCOD computers and sums the total assets by class of assets for each cluster. The auditing system then provides a notification that the customer must provide additional payment should any given cluster have additional assets be activated without being paid for.

### DETAILED DESCRIPTION OF DRAWINGS

The detailed description will refer to the following drawings, wherein like numerals refer to like elements, and wherein:

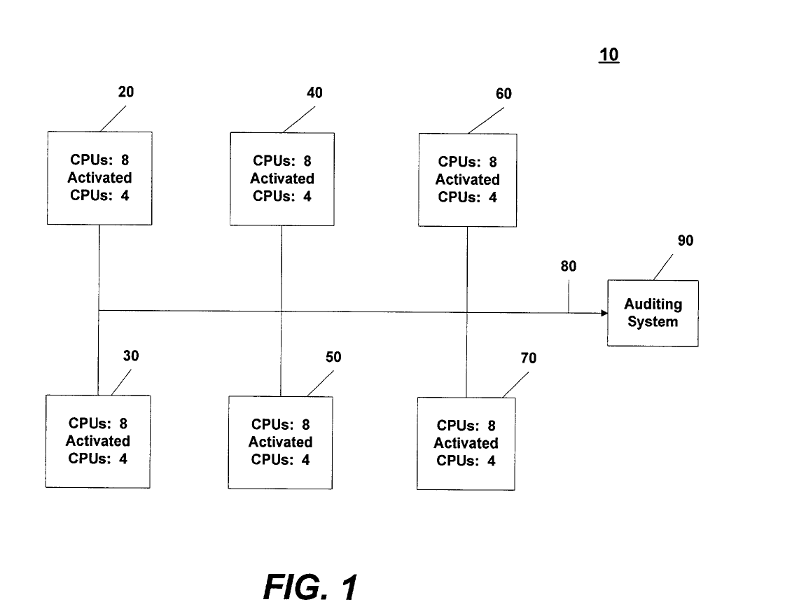

FIG. 1 illustrates a multiple computer network that is connected to a vendor asset database;

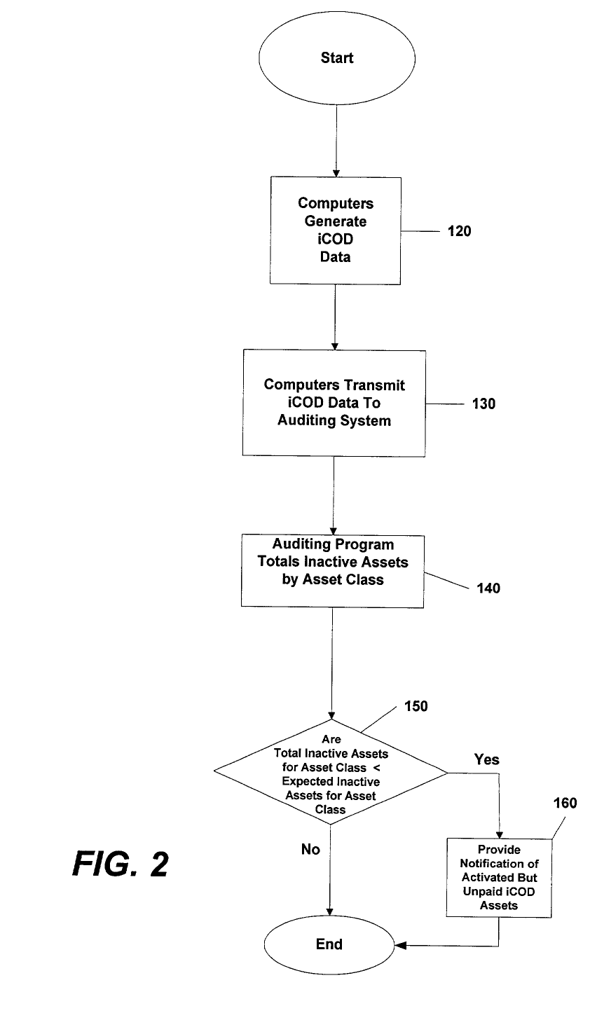

FIG. 2 is a flowchart illustrating an iCOD auditing process for measuring assets from the multiple computer network; and

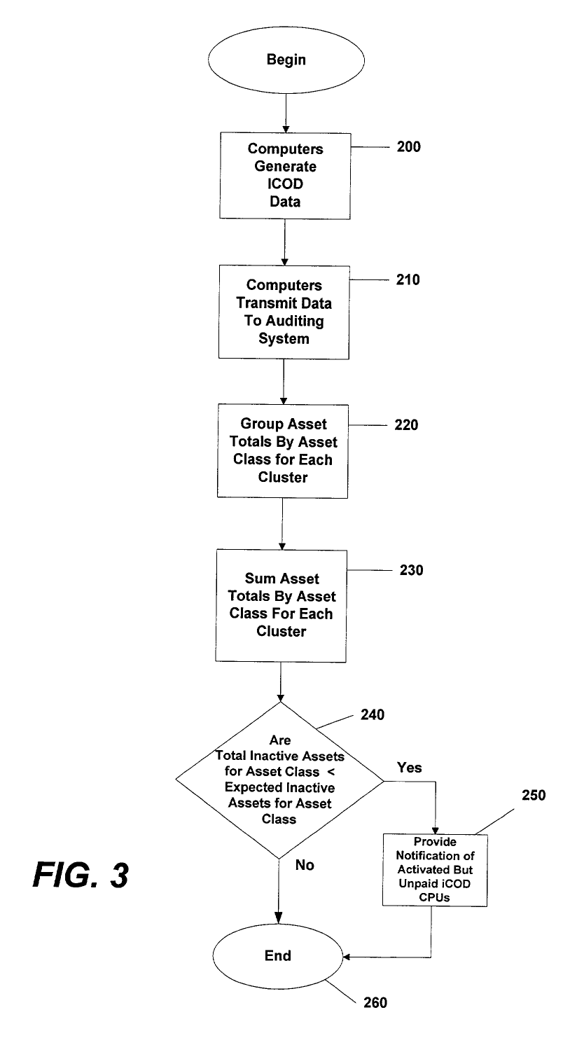

FIG. 3 is a flowchart illustrating the iCOD auditing process for measuring assets by clusters of computers.

### DETAILED DESCRIPTION

A multiple computer (“multi-computer”) auditing system is disclosed that audits usage of assets for a group of iCOD computers rather than for a single iCOD computer, where an asset may be a computing component. Assets may be grouped into different classes, such as central processing units (CPUs), hard disk capacity, input/output (I/O) ports, memory or any other computer component. The assets on the iCOD computers may be assets covered by an iCOD agreement, and may thus be termed iCOD assets. However, iCOD computers may include non-iCOD assets as well. The multi-computer auditing system provides a method of auditing that is more flexible for both the iCOD customer and the vendor. The iCOD customer will not need to pay extra for activating inactive iCOD assets in one iCOD computer while deactivating active assets of similar asset classes in another iCOD computer but rather is able to “shift” iCOD assets from one iCOD computer to another iCOD computer.

FIG. 1 illustrates a multiple computer (“multi-computer”) network 10 that includes six iCOD computers 20, 30, 40, 50, 60, 70 connected to each other using a network 80 as well as being connected to an auditing system 90 residing at a system vendor. The network 80 may be a TCP/IP network, although other protocols and other types of networks may be used as well. The multi-computer network 10 can have any number of iCOD computers, although a network with only a single iCOD computer would be audited individually. The auditing system 90 includes an asset database and software for auditing and notifying iCOD customers.

Each iCOD computer may include assets of at least one asset class and may include assets of multiple asset classes. Each of the iCOD computers 20, 30, 40, 50, 60, 70 has a number of monitored assets of the same asset class as the other iCOD computers, and each iCOD computer has activated only some of the iCOD assets. In this illustration, each iCOD computer has eight CPUs, with only four CPUs activated for each iCOD computer. Different iCOD computers can be connected together on the same network 80 and audited together, as long as the system vendor is willing to price the assets in a given asset class identically or to use a weighting factor that will adjust for the differences in assets in a given asset class (such as adjusting for the difference between faster and slower CPUs).

Each of the iCOD computers 20, 30, 40, 50, 60, 70 may include an iCOD collection software agent (not shown) that generates iCOD audit data that may include monitored usage data. The iCOD audit data may be in the form of an iCOD audit report and may be used by the system vendor in auditing computer usage and in billing the customer if necessary. The iCOD audit reports each may include counts of both total assets and inactive assets, grouped by asset class such as CPUs, hard disk capacity, memory, or I/O ports. The iCOD collection software agent may audit all assets, not only iCOD assets. Each iCOD computer 20, 30, 40, 50, 60, 70 is set by the system vendor to periodically transmit iCOD data to the auditing system 90. Any changes to the iCOD configuration of the iCOD computer, such as asset activation or deactivation, are also reported to the auditing system 90.

FIG. 2 illustrates an auditing process for measuring assets from the multi-computer network 10. The overall auditing process begins when each of the six iCOD computers 20, 30, 40, 50, 60, 70 generates individual iCOD data using the iCOD collection software agent found on the iCOD computer (step 120). Each iCOD collection software agent on each iCOD computer 20, 30, 40, 50, 60, 70 generates iCOD data and transmits the iCOD data as an iCOD audit report to the auditing system 90 (step 130). Data may be transmitted by encrypted e-mail or alternately may also be transmitted by Secure HTTP (HTTP/S) or any other data transport mechanism.

The auditing system 90 then receives the iCOD data from each of the iCOD computers, decrypting the iCOD data when necessary. The auditing system 90 thus obtains a total number of assets for each asset class and a total number of inactive assets for each asset class for each computer 20, 30, 40, 50, 60, 70 and stores this iCOD data in a memory. Once the auditing system 90 has received all of the iCOD data, the auditing system 90 calculates separate totals of assets and inactive assets for each asset class for the multi-computer network 10 (step 140).

The auditing system 90 then compares, for each class of assets, the reported total number of inactive assets in that class with the expected total number of inactive assets in that class (step 150). Thus, for example, the auditing system 90 in FIG. 1 will compare the reported total number of inactive CPUs with the expected total number of inactive CPUs. The expected total number of inactive assets for a given asset class corresponds to the number of inactive assets in that class that the iCOD customer has chosen not to activate and pay for. Any decrease in the number of inactive assets in a given asset class without a corresponding decrease in the expected number of inactive assets in that asset class signals that iCOD assets of that asset class have been activated without payment.

The auditing system 90 completes the audit if the number of inactive assets has not decreased below the expected total number of inactive assets for any of the asset classes. On the other hand, the auditing system 90 may run a process to provide a notification if the number of inactive assets for any asset class is less than the expected total number of inactive assets for that asset class, signifying that the iCOD customer must pay for newly activated assets (step 160). The iCOD auditing system may provide a combined notification that lists each class of assets for which there are previously inactive assets that have been activated without payment. This notification may be a payment reminder sent to the iCOD customer, an invoice, an instruction to dispatch a vendor representative to resolve the payment difference, or may be some other notice requesting payment for the unpaid iCOD assets. The auditing system 90 thus assesses customer usage by the entire computer network 10 rather than by individual iCOD computers. Asset classes such as CPUs, hard disk capacity, and I/O ports, may be audited, where the auditing program adds up asset totals for different classes of assets and compares the asset totals with expected asset totals for each asset class.

Comparisons are made between expected inactive assets (representing assets that have not been paid for) and actual inactive assets because the amount of active assets in an iCOD computer may be expanded or extended by the iCOD customer adding owned CPUs, memory, or other components that are not covered by an iCOD contract. Adding assets that are already owned by the iCOD customer changes the active asset totals of the iCOD computer, but does not change the inactive asset totals—and thus does not affect the assets that have been activated without payment. For iCOD computers that cannot be expanded by adding non-iCOD assets, the auditing system may be designed to compare active assets with a previously purchased total of active assets. Active assets may be measured instead of measuring inactive assets directly in such non-extensible iCOD computers because active assets cannot be extended without activating inactive assets already present in non-extensible iCOD computers. For such non-extensible iCOD computers, an increase in active assets necessarily corresponds to a decrease in inactive notification if the total number of active assets exceeds a pre-determined (and purchased) total of active assets.

To illustrate how multi-computer auditing works, suppose each of the computers 20, 30, 40, 50, 60, 70 in FIG. 1 have a total of eight CPUs, four of which are inactive. The iCOD customer initially pays to activate four CPUs for each computer 20, 30, 40, 50, 60, 70 for a sum total of 24 CPUs. At some future time, the iCOD customer decides to change the configuration of the 24 CPUs by deactivating one of the CPUs in the third computer 40 and subsequently activating a fifth CPU in the first computer 20. Deactivating an asset such as a CPU in one computer prior to activating another asset of the same asset class in another computer is preferred because the net number of inactive assets in the asset class does not decrease. However, each computer 20, 30, 40, 50, 60, 70 also permits activating the additional asset prior to deactivating the asset of the same asset class without incurring a charge, provided the deactivation takes place within a certain grace period. The iCOD customer keeps the rest of the computers with only four CPUs activated, leaving the total number of active CPUs at 24. This “shift” of one CPU from the third computer 40 to the first computer 20 does not affect the audit results for the iCOD customer, because the auditing system 90 audits the CPU counts from the iCOD reports of all the six computers as a group rather than from the reports of each computer 20, 30, 40, 50, 60, 70 individually. The total number of CPUs in this case remains at 24, even as the first computer 20 now has five CPUs activated and the third computer 40 has three CPUs activated. The iCOD customer thus has the ability to pool all of the iCOD customer's iCOD resources over the entire network; the iCOD customer can juggle iCOD assets as needs change without incurring an additional cost or making an additional purchase of iCOD assets as long as there is no net change in inactive assets.

Another embodiment of the invention allows the customer to group parts of the iCOD customer's network for auditing and billing purposes. In this embodiment, the iCOD customer specifies that certain computers, which may be either new or existing iCOD computers, are part of a cluster for billing purposes. The iCOD customer can group one set of computers into a first cluster, a second set of computers into a second cluster, and so forth. A cluster can include as many as all of an iCOD customer's computers or as few as only one computer. The cluster embodiment allows for greater flexibility in allowing an iCOD customer to group and sub-group computers and to purchase the use of the iCOD assets for the computers accordingly. In addition, the cluster embodiment permits the iCOD customer to more closely approximate a pay-per-use or leasing model while still retaining title to assets purchased and activated under an iCOD contract. The iCOD customer, as with the single group embodiment, purchases licenses for all of the assets that are activated for a given cluster but is allowed to shift licenses for the assets between computers within a cluster as computing needs change. A corporate iCOD customer can set up different clusters for different organizations, sub-organizations or groups within the larger corporation. Moreover, the cluster embodiment allows for more reasonable pricing of clusters with built-in redundancy: an iCOD customer can purchase a cluster of iCOD computers, activate only some of the CPUs or hard disks, and then swap capacity when a CPU or hard disk fails. The iCOD customer can save money by deactivating failed CPUs or capacity in the cluster and subsequently activating functional CPUs or capacity as “hot spares” in the same cluster.

Referring to FIG. 1, the iCOD customer could group the first and third computers 20, 40 together as cluster A and group the second, fourth and sixth 30, 50, 70 computers as cluster B, and keep the fifth computer 60 as a single computer cluster. The vendor would notify the iCOD customer for payment according to the expected iCOD CPU totals for each cluster.

Referring to FIG. 3, the auditing process for the cluster embodiment begins when each of the computers 20, 30, 40, 50, 60, 70 generate its own iCOD data, which may be in the form of an iCOD audit report, detailing the quantity of inactive assets by class that are used on that computer (step 200). Each computer will transmit its iCOD data to the auditing system 90 (step 210), and may also encrypt the iCOD data prior to transmission. An auditing program on the asset database 90 will then check for the cluster membership of each computer 20, 30, 40, 50, 60, 70 (step 220) and add the asset totals for each cluster within each asset class (step 230).

For example, suppose that three of the computers 20, 40, 60 were grouped into cluster A and the three other computers 50, 60, 70 were grouped into cluster B. In the example, the auditing system 90 in FIG. 1 will sum up the number of inactive CPUs for cluster A and compare this sum with the expected total of inactive CPUs for cluster A (step 240). The auditing system 90 will then perform similar calculations for cluster B and compare the reported total of inactive iCOD CPUs for cluster B with the expected number of inactive iCOD CPUs (step 240). The auditing system 90 will decide whether or not each cluster has any CPUs (or other iCOD capacity) that have been activated without payment. The auditing system 90 provides a notification, which may be a notice to the iCOD customer to send a payment, or may also be a bill, if any of the clusters has fewer inactive assets than expected (step 250), but simply ends if no cluster has any reductions in inactive assets. The iCOD customer is thus able to shift iCOD assets within a cluster, but cannot shift iCOD assets between clusters without re-defining the clusters in the auditing system 90. The iCOD customer may be given the capacity to re-define the clusters upon issuing a system administration command, but can also re-define the clusters at any time by contacting the vendor. As with the non-cluster embodiment, the auditing system 90 may be designed to measure and compare active assets by class with a previously purchased total of active assets for that class in systems that are not extensible by adding non-iCOD assets.

The cluster embodiment thus provides the vendors with additional flexibility in managing and pricing iCOD systems. Likewise the iCOD customer is afforded with more options in purchasing computers and groups of computers on a computer network. An iCOD customer could still choose to group all of the iCOD assets into a single cluster, essentially creating the same system as the non-cluster embodiment. Alternately, the iCOD customer could create a cluster consisting of a single computer, allowing that cluster to be billed as a single iCOD computer.

While the invention has been described with reference to the above embodiments it will be appreciated by those of ordinary skill in the art that various modifications can be made to the structure and function of the individual parts of the system without departing from the spirit and scope the invention as a whole.

In the claims:

1. A system for on-demand computer pricing, comprising:
a plurality of computers, wherein each computer has at least one asset class, each asset class having a number of monitored assets associated with the at least one asset class, wherein the monitored assets comprise active assets and inactive assets in the at least one asset class and wherein the plurality of computers comprise a total amount of inactive assets in the at least one asset class;
a network connection connecting the plurality of computers; and
an auditing system operably connected to the plurality of computers using the network connection, the auditing system, comprising:
a memory that stores the number of monitored assets for each asset class for each computer, and
a notification process that provides a notification when the total amount of inactive assets in at least one asset class for all of the plurality of computers changes.

2. The system of claim 1, wherein the notification is an invoice.

3. The system of claim 1, wherein each computer transmits an audit of the monitored assets for the computer.

4. The system of claim 1, wherein the auditing system generates the notification if the total amount of inactive assets of the at least one asset class is less than an expected total amount of inactive assets for the at least one asset class.

5. The system of claim 1, wherein the auditing system generates the notification if the total amount of active assets of the at least one asset class is greater than an expected total amount of active assets for the at least one asset class.

6. The system of claim 1, wherein the at least one asset class includes a number of central processing units (CPUs).

7. The system of claim 1, wherein the at least one asset class includes hard disk capacity.

8. The system of claim 1, wherein the at least one asset class includes memory.

9. The system of claim 1, wherein the at least one asset class includes input/output (I/O) ports.

10. A method for measuring at least one monitored asset belonging to at least one asset class over a network with a plurality of computers comprising:
receiving a quantity of assets of the at least one asset class for each computer on the network;
summing the quantity of assets of the at least one asset class for all of the plurality of computers on the network, thereby forming a sum of assets; and
providing a notification if the sum of assets differs from a previously specified total for the assets for the at least one asset class, wherein the assets may be either active or inactive.

11. The method of claim 10, wherein receiving the quantity of assets further includes decrypting the quantity of assets.

12. The method of claim 10, further comprising providing the notification when the sum of inactive assets of the at least one asset class is less than an expected total of inactive assets for the at least one asset class.

13. The method of claim 10, further comprising providing the notification when the sum of active assets for the at least one asset class is greater than an expected total of active assets for the at least one asset class.

14. The method of claim 10, wherein providing the notification further comprises requiring a payment.

15. The method of claim 10, wherein providing the notification further comprises issuing an invoice.

16. A method for measuring at least one monitored asset belonging to at least one asset class over a network with a plurality of computers comprising the steps of:
measuring a quantity of assets of at least one asset class from each computer on the network;
transmitting the quantity of assets for at least one asset class for each computer to an asset database; and
receiving a notification if a total quantity of assets for the at least one asset class for all of the computers on the network differs from a previously specified total quantity of assets of the at least one asset class for all of the computers on the network, wherein the assets may be either active or inactive.

17. The method of claim 16, wherein measuring the quantity of assets of the at least one asset class further comprises measuring a quantity of inactive assets for the at least one asset class.

18. The method of claim 16, wherein measuring the quantity of assets of the at least one asset class further comprises measuring a quantity of active monitored assets for the at least one asset class.

19. The method of claim 16, wherein transmitting the quantity of assets further includes encrypting the quantity of assets.

20. The method of claim 16, further comprising receiving the notification when the total quantity of inactive assets of the at least one asset class is less than an expected total quantity of inactive assets for the at least one asset class.

21. The method of claim 16, further comprising receiving the notification when the total quantity of active assets for the asset class is greater than an expected total quantity of active assets for the asset class.

22. The method of claim 10, wherein receiving the notification further comprises receiving a payment request.

23. The method of claim 10, wherein receiving the notification further comprises receiving an invoice.

24. A method for measuring at least one monitored asset of at least one asset class in a network of computers, comprising:
grouping the computers into at least one cluster, wherein the at least one cluster includes at least one computer;
receiving a measurement of the quantity of assets by asset class from each computer in the network of computers;
summing, for each cluster, the quantity of assets by asset class for each cluster, thereby forming a total quantity of assets for each asset class for each cluster;
comparing, for each cluster, the total quantity of assets for each asset class for each cluster with a previously specified total quantity of assets for each asset class for each cluster; and
providing a notification if the total quantity of assets for a given asset class for a given cluster is different than the previously specified total quantity of assets for the given asset class for the given cluster, wherein the assets may be either active or inactive.

25. The method of claim 24, wherein grouping the computers into at least one cluster further includes registering the computers into the at least one cluster by issuing a command from one of the plurality of computers.

26. The method of claim 24, wherein receiving the measurement of the quantity of assets further includes decrypting the measurement.

27. The method of claim 24, wherein providing the notification further comprises requiring a payment.

28. The method of claim 24, wherein providing the notification further comprises issuing an invoice.

29. The method of claim 24, further comprising providing the notification if the total quantity of inactive assets for any one asset class for any given cluster is less than the previously specified total quantity of inactive assets for that asset class for that given cluster.

30. The method of claim 24, further comprising providing the notification if the total quantity of active assets for any one asset class for any given cluster exceeds the previously specified total quantity of active assets for that asset class for that given cluster.
